(19) United States
(12) Patent Application Publication
(10) Pub. No.: US 2024/0047672 A1
(43) Pub. Date: Feb. 8, 2024

(54) POSITIVE ELECTRODE ACTIVE MATERIAL, POSITIVE ELECTRODE, LITHIUM ION BATTERY, AND METHOD FOR PRODUCING POSITIVE ELECTRODE ACTIVE MATERIAL

(71) Applicant: TOYOTA JIDOSHA KABUSHIKI KAISHA, Toyota-shi (JP)

(72) Inventor: Kenji YOKOE, Toyota-shi (JP)

(21) Appl. No.: 18/315,518

(22) Filed: May 11, 2023

(30) Foreign Application Priority Data
Aug. 2, 2022 (JP) 2022-123406

(51) Int. Cl. H01M 4/525; H01M 4/505; H01M 10/0525; H01M 4/04

(52) U.S. Cl. CPC H01M 4/525; H01M 4/505; H01M 10/0525; H01M 4/04; H01M 2004/028

(57) ABSTRACT

The positive electrode active material includes a lithium nickel composite oxide powder. The positive electrode active material has a relationship of the formula (1) “0.1≤d×R×≤0.4” and the formula (2) “d≤2.7”. In formulae (1) and (2), d has units of μm. d represents D50 of the lithium nickel composite oxide powder. R is a dimensionless quantity. R represents a ratio of a height of a second peak with respect to a height of a first peak in an absorption spectrum of oxygen by X-ray absorption fine structure spectroscopy. The first peak has a peak top within 529 eV to 530 eV. The second peak has a peak top within 533 eV to 534 eV.

### CROSS-REFERENCE TO RELATED APPLICATION

This application claims priority to Japanese Patent Application No. 2022-123406 filed on Aug. 2, 2022, incorporated herein by reference in its entirety.

### BACKGROUND

### 1. Technical Field

The present disclosure relates to a positive electrode active material, a positive electrode, a lithium ion battery, and a method for producing the positive electrode active material.

### 2. Description of Related Art

Japanese Unexamined Patent Application Publication No. 2011-116580 (JP 2011-116580 A) discloses a nickel cobalt manganese composite hydroxide having a small particle diameter and uniform particle size distribution.

### SUMMARY

Lower resistance of a lithium ion battery (hereinafter can be abbreviated as a “battery”) is required. For example, the specific surface area of a positive electrode active material can be increased by crushing the positive electrode active material. Due to an increase in the specific surface area, the reaction area can be increased. As a result, a reduction in the resistance is expected.

However, a new surface can be generated by crushing the positive electrode active material. The new surface is active. Due to a reaction of the new surface, a resistance component can be generated. An increase in the resistance component may result in an increase in the resistance.

An object of the present disclosure is to reduce the resistance.

A technical configuration and effects of the present disclosure will be described below. However, an effect mechanism of the present specification includes speculation. The effect mechanism does not limit the technical scope of the present disclosure.

1. A positive electrode active material includes lithium nickel composite oxide powder.

The positive electrode active material has relationships represented by the following formula (1) and the following formula (2).

0.1≤d×R×R≤0.4 (1)

d≤2.7 (2)

In the above formula (1) and the above formula (2), d has a unit of μm. d represents D50 of the lithium nickel composite oxide powder.

R is a dimensionless quantity. R represents a ratio of a height of a second peak with respect to a height of a first peak in an absorption spectrum of oxygen by X-ray absorption fine structure spectroscopy.

The first peak has a peak top within 529 eV to 530 eV.

The second peak has a peak top within 533 eV to 534 eV.

“d×R×R (hereinafter also referred to as “dR²”)” in the above formula (1) includes information on a particle size and information on a generation amount of the resistance component. According to the new findings disclosed in the present disclosure, when D50 is 2.7 μm or less and dR² is 0.1 to 0.4, a reduction in the resistance is expected. This is because it is considered that the effect of reducing the resistance due to the increase in the reaction area exceeds the effect of increasing the resistance due to the generation of the resistance component.

2. In the positive electrode active material according to “1”, a relationship of the following formula (3) may be further satisfied:

0.32≤R≤0.49 (3).

When the relationship of the above formula (3) is satisfied, the reduction in the resistance is expected.

3. In the positive electrode active material according to “1” or “2”, a ratio of an amount of substance of Ni with respect to a total amount of substance of atoms other than Li and oxygen in the lithium nickel composite oxide powder may be 0.5 or more.

Hereinafter, the “lithium nickel composite oxide” can be abbreviated as “LNO”. Further, “the ratio of the amount of substance of Ni with respect to the total amount of substance of the atoms other than Li and oxygen in the LNO powder” can be abbreviated as a “Ni ratio”. The LNO having the Ni ratio of 0.5 or more is also referred to as a “high nickel material”. The high nickel material tends to have a high capacity. On the other hand, when the high nickel material is crushed, the resistance component tends to be generated. In particular, in the high nickel material, it can be important to satisfy the relationships of the above formula (1) and the above formula (2).

4. In the positive electrode active material according to any one of “1” to “3”, the lithium nickel composite oxide powder may have a composition represented by the following formula (4).

Li₍₁₊ₓ₎Ni_{y}Co_{z}Mn_{(1-y-z)}MₐO_{(2-b)}C_{b} (4)

In the above formula (4), x, y, z, a, and b satisfy relationships of 0≤x≤0.7, 0.5≤y≤0.8, 0.1≤z≤0.2, 0≤a≤0.1, and 0≤b≤0.5, respectively.

M is at least one selected from the group consisting of Zr, Mo, W, Mg, Ca, Na, Fe, Cr, Zn, Si, Sn, Al, and Ag.

C is at least one selected from the group consisting of F, Cl, and Br.

The LNO may further include additional atoms (for example, Co and Mn) in addition to Ni.

5. A positive electrode includes the positive electrode active material according to any one of “1” to “4”.

6. A lithium ion battery includes the positive electrode according to “5”.

7. A method for producing a positive electrode active material includes the following (a) and (b):
(a) preparing lithium nickel composite oxide powder; and
(b) producing the positive electrode active material by crushing the lithium nickel composite oxide powder in an inert gas atmosphere.

Oxygen and carbon dioxide in the crushing atmosphere is considered to promote the generation of the resistance component (for example, Li₂CO₃). When the LNO powder is crushed in the inert gas atmosphere, the relationships of the above formula (1) and the above formula (2) tend to be satisfied. This is because it is considered that the LNO can be crushed while the generation of the resistance component is reduced.

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure. The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an example of an absorption spectrum of oxygen;

FIG. 2 is a schematic flow chart of a process for producing a positive electrode active material according to the present embodiment; and

FIG. 3 is a conceptual diagram of a lithium ion battery according to the present embodiment.

### DETAILED DESCRIPTION OF EMBODIMENTS

### Terms and Definitions, Etc

Statements of “comprising,” “including,” and “having,” and variations thereof (for example “composed of”) are open-ended formats. The open-ended format may or may not include an additional element in addition to a required element. A statement of “consisting of” is a closed format. However, even when the statement is the closed format, normally associated impurities and additional elements irrelevant to the disclosed technique are not excluded. A statement “substantially consisting of” is a semi-closed format. The semi-closed format allows addition of an element that does not substantially affect the basic and novel characteristics of the disclosed technique.

Expressions such as “may” and “can” are used in the permissive sense of “having the possibility of” rather than in the obligatory sense of “must”.

For example, a numerical range such as “m % to n %” includes an upper limit value and a lower limit value. That is, “m % to n %” indicates a numerical range of “m % or more and n % or less”. In addition, “m % or more and n % or less” includes “more than m % and less than n %”. Further, a numerical value selected as appropriate from within the numerical range may be used as a new upper limit value or a new lower limit value. For example, a new numerical range may be set by appropriately combining numerical values within the numerical range with numerical values described in other parts of the present specification, tables, drawings, and the like.

For multiple steps, actions, operations, and the like included in various methods, the execution order thereof is not limited to the described order unless otherwise specified. For example, the multiple steps may proceed concurrently. For example, the multiple steps may occur one after the other.

All numerical values are modified by the term “approximately.” The term “approximately” can mean, for example, ±5%, ±3%, ±1%, and the like. All numerical values can be approximations that may vary depending on the mode of use of the disclosed technique. All numerical values can be displayed with significant digits. A measured value can be an average value of multiple measurements. The number of measurements may be three or more, five or more, or ten or more. In general, it is expected that the reliability of the average value improves as the number of measurements increases. The measured value can be rounded by rounding based on the number of significant digits. The measured value can include errors and the like associated with, for example, the detection limit of a measuring device.

Where a compound is represented by a stoichiometric composition formula (e.g., “LiCoO₂”), the stoichiometric composition formula is only representative of the compound. The compound may have a non-stoichiometric composition. For example, when lithium cobaltate is expressed as “LiCoO₂”, unless otherwise specified, lithium cobaltate is not limited to the composition ratio of “Li/Co/O=1/1/2” and may include Li, Co and O at any composition ratio. Further, doping with trace elements, substitution, etc. can also be permitted.

“D50” indicates a particle size in which the cumulative frequency from the smaller particle size reaches 50% in the volume-based particle size distribution. The particle size distribution can be measured by a laser diffraction particle size distribution measuring apparatus. The measurement sample can be prepared by dispersing the powder in water by sonication.

“Specific surface area” refers to the surface area per unit mass. The specific surface area can be derived from the adsorption isotherm by BET1 point method. The adsorption isotherm is measured by a gas adsorption quantity measuring device.

Measuring XAFS

R in the above formula (1) is determined by X-ray Absorption Fine Structure (XAFS). Examples of the equipment capable of measuring XAFS include a beamline “BL1N2” of “Aichi Synchrotron Optical Center”.

By holding the positive electrode active material (powder) on the base material, a sample is produced. For example, a positive electrode containing a positive electrode active material may be used as a sample. Total Electron Yield (TEY) The method measures the absorption spectrum of oxygen (O) in the soft X-ray range of 500 to 580 eV.

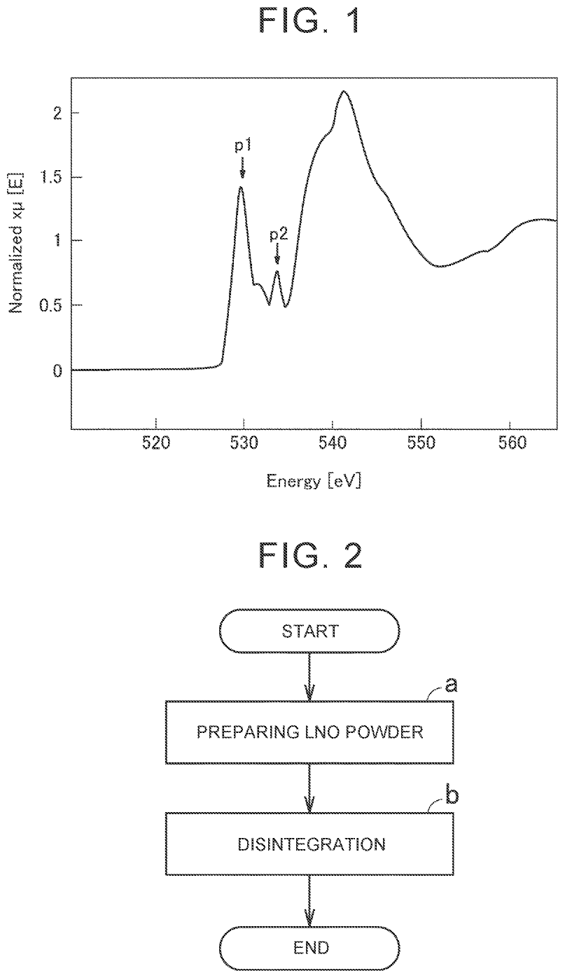

FIG. 1 is an example of an absorption spectrum of oxygen. The first peak p1 has a peak top within 529 to 530 eV. The first-peak p1 is believed to be derived from oxygenation in LNO. The second peak p2 has a peak top within 533 to 534 eV. It is believed that the second peak p2 is derived from oxygen in the resistive component. The resistive components may include, for example, Li₂CO₃, etc. The spectrum is normalized by XAFS analysis software “Athena”. In the normalized spectrum, the ratio of the height of the second peak p2 to the height of the first peak p1 is determined. The peak height ratio is “R”.

Positive Electrode Active Material

The positive electrode active material includes LNO powder. LNO powder is an aggregate of LNO grains. The positive electrode active material satisfies the following relationships (1) and (2).

0.1≤dR²≤0.4 (1)

d≤2.7 (2)

When the relationships of the above formulas (1) and (2) are satisfied, the resistance is expected to be reduced. dR² of the above formula (1) may be, for example, 0.16 or more, 0.17 or more, or 0.20 or more. dR² may be, for example, 0.38 or less, 0.28 or less, or 0.27 or less.

The positive electrode active material may further satisfy, for example, the relationship of the following formula (3).

0.32≤R≤0.49 (3)

When the relationship of the above formula (3) is satisfied, the reduction in the resistance is expected. R may be, for example, 0.33 or more and 0.38 or more. R may be, for example, 0.45 or less.

D50 of LNO powder may be, for example, 1.7 μm or less, 1.6 μm or less, 1.5 μm or less, 1.4 μm or less, or 1.2 μm or less. D50 of LNO powder may be, for example, 1.0 μm or more. That is, d may satisfy, for example, a relationship of 1≤d≤1.7, 1≤d≤1.6, 1≤d≤1.5, 1≤d≤1.4, or 1≤d≤1.2.

The size profile of LNO powder may be, for example, between 0.1 and 10 micrometers. That is, the minimum value (Dmin) may be 0.1 μm, and the maximum value (Dmax) may be 10 μm. The width of the particle size distribution may be, for example, 0.2 to 4 μm.

The specific surface area of LNO powder may be, for example, 1.2 m²/g or more, 1.4 m²/g or more, 1.7 m²/g or more, or 2.1 m²/g or more. The specific surface area of LNO powder may be, for example, 2.5 m²/g or less.

LNO undergoes a positive electrode response. LNO may have any crystalline configuration. LNO may have, for example, a layered rock salt-type construction. LNO includes a Li, a Ni, and O. LNO may consist of Li, a Ni, and O. LNO is a host-guest system. Ni and O may form a host-structure. Li behaves as a guest. The host-structure may contain additional atoms in addition to Ni and O. The host-structure may include, for example, at least one selected from the group consisting of Co, Mn, and Al. Ni fraction of LNO may be, for example, 0.5 or more. When Ni ratio is 0.5 or more, in order to satisfy the relation of the above formulas (1) and (2), for example, in the crushing process, strict atmospheric control or the like may be required. Ni ratio may be, for example, 0.6 or more, 0.7 or more, or more, or 0.9 or more.

LNO may have, for example, a composition represented by the following formula (4).

Li₍₁₊ₓ₎Ni_{y}Co_{z}Mn_{(1-y-z)}MaO_{(2-b)}C_{b} (4)

In the above formula (4), x, y, z, a, and b satisfy the relationship of 0≤x≤0.7, 0.5≤y≤0.8, 0.1≤z≤0.2, 0≤a≤0.1, and 0≤b≤0.5.

M is at least one selected from the group consisting of Zr, Mo, W, Mg, Ca, Na, Fe, Cr, Zn, Si, Sn, Al, and Ag.

C is at least one selected from the group consisting of F, Cl, and Br.

In the above formula (4), y, for example, may satisfy 0.5≤y≤0.6, 0.6≤y≤0.7, or 0.7≤y≤0.8.

Generally, in a LNO powder, the individual LNO particles may be secondary particles in which a large amount of primary particles are aggregated. The secondary particles may typically comprise 100 or more primary particles. LNO powder in the present embodiment is crushed. The secondary particles after crushing consist of a relatively small amount of primary particles. LNO powder may be crushed to the primary particle-level. The secondary particles after crushing may be composed of, for example, 30 or less, 20 or less, 10 or less, 5 or less, or 3 or less primary particles. The primary particles may be present alone. The number of primary particles contained in the secondary particles can be measured in Scanning Electron Microscope (SEM) images of the positive electrode active material (powder). In SEM images, for example, when two primary particles overlap, the primary particles on the back side are not confirmed. However, in the present embodiment, the number that can be confirmed in SEM images is regarded as the number of primary particles included in the secondary particles.

The secondary particles and the primary particles may each independently have any shape. The secondary particles and the primary particles may each independently be, for example, spherical, ellipsoidal, flake-like, columnar, or the like.

Method for Producing Positive Electrode Active Material

FIG. 2 is a schematic flowchart of a method for producing a positive electrode active material according to the present embodiment. Hereinafter, the “method for producing a positive electrode active material according to the present embodiment” may be abbreviated as “the present production method”. The process comprises “(a) preparing LNO powder” and “(b) crushing”.

(a) Preparing LNO Powder

The process includes providing a LNO powder. LNO powder may be prepared by any methods. For example, LNO powder may be synthesized by a co-precipitation method. For example, LNO powder may be synthesized in the following manner.

Sulfates such as Ni are prepared. The sulfate is dissolved in water to form an acidic aqueous solution. For example, nickel sulfate, cobalt sulfate, and manganese sulfate may be dissolved in water to form an acidic aqueous solution. For example, a neutralization reaction may occur by dropping an aqueous alkali solution into an aqueous acidic solution. The alkaline aqueous solution may include, for example, an aqueous NaOH solution and an ammoniacal solution. A neutralization reaction may form a precipitate. The precipitate is believed to comprise a complex hydroxide (precursor). The precipitate is washed and dried to form a dry matter. The mixture is formed by mixing the dried product with the lithium compound. The lithium compound may include, for example, Li₂CO₃, LiOH, and the like. The mixture is subjected to a heat treatment. The heat treatment may also be referred to as “calcination.” The heat treatment temperature may be, for example, 500 to 1000° C. The heat treatment time may be, for example, 5 to 30 hours. From the above, LNO powder is synthesized.

(b) Disintegration

The process comprises crushing LNO powder in an inert atmosphere. When the crushing treatment is performed in an inert gas atmosphere, a positive electrode active material satisfying the relationships of the above formulas (1) and (2) tends to be easily produced. In the present production method, a dry crushing apparatus can be used. For example, a dry jet mill or the like may be used. The inert gas atmosphere may include, for example, nitrogen, argon, helium, neon, and the like. The oxygen concentration and the carbon dioxide concentration in the inert gas atmosphere are reduced as much as possible.

After the crushing of LNO powder, for example, a classification treatment, a sizing treatment, or the like may be further performed. For example, an airflow classifier or the like may be used. The classification process may also be carried out under an inert gas atmosphere. The classification process is also performed under an inert gas atmosphere, so that the resistance component is expected to be reduced.

A Lithium Ion Battery

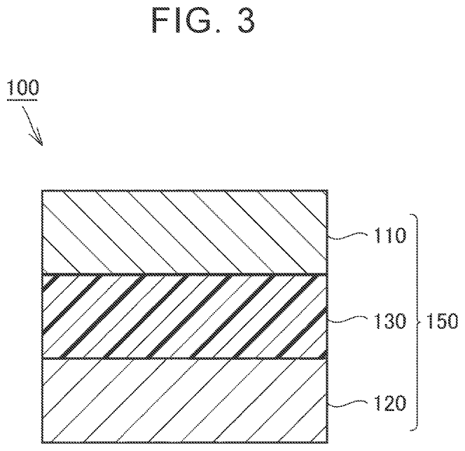

FIG. 3 is a conceptual diagram of a lithium ion battery according to the present embodiment. Hereinafter, the “lithium ion battery in the present embodiment” may be abbreviated as “the present battery”. The battery 100 may be a liquid-based battery, a polymer battery, or an all-solid-state battery. That is, the battery 100 may include a liquid electrolyte, a gel electrolyte, or a solid electrolyte.

The battery 100 may include an exterior body (not shown). The outer casing may house the power generation element 150. The sheath may have any form. The outer casing may be, for example, a pouch made of a metal foil laminate film or a case made of metal. The case may be, for example, cylindrical or square.

The battery 100 includes a power generation element 150. The power generation element 150 includes a positive electrode 110, a separator 130, a negative electrode 120, and an electrolyte (not shown). The power generation element 150 may also be referred to as an electrode assembly, an electrode group, or the like. The power generation element 150 may be, for example, a stacked type or a wound type.

Positive Electrode

The positive electrode 110 may have, for example, a sheet shape. The positive electrode 110 may include, for example, a positive electrode current collector and a positive electrode active material layer. The positive electrode current collector may include, for example, an Al foil. The positive electrode active material layer may be disposed on the surface of the positive electrode current collector. The positive electrode active material layer includes the aforementioned positive electrode active material. As long as the positive electrode 110 includes the aforementioned positive electrode active material, the positive electrode 110 may include an additional positive electrode active material. For example, the positive electrode active material layers may further include LiFePO₄, and the like. The positive electrode active material layer may further include a conductive material, a binder, and the like in addition to the positive electrode active material. The positive electrode active material layers may include, for example, acetylene black (AB), polyvinylidene fluoride (PVDF), and the like.

Negative Electrode

The negative electrode 120 may have, for example, a sheet shape. The negative electrode 120 may include, for example, a negative electrode current collector and a negative electrode active material layer. The negative electrode current collector may include, for example, a Cu foil. The negative electrode active material layer may be disposed on the surface of the negative electrode current collector. The negative electrode active material layer includes a negative electrode active material. The negative electrode active material may be in a powder form or a sheet form. The negative electrode active material may include, for example, at least one selected from the group consisting of natural graphite, artificial graphite, soft carbon, hard carbon, Si, SiOₓ (0<x<2), Si based alloy, Sn, SnOₓ (0<x<2), Li, Li based alloy, and Li₄Ti₅O₁₂. The negative electrode active material layer may further include a conductive material, a binder, and the like. The negative electrode active material layers may include, for example, vapor-grown carbon fiber (VGCF), carboxymethyl cellulose (CMC), styrene-butadiene rubber (SBR), and the like.

Separator

The separator 130 is interposed between the positive electrode 110 and the negative electrode 120. The separator 130 separates the positive electrode 110 from the negative electrode 120. In the case of a liquid-based battery, the separator 130 may include, for example, a porous sheet made of resin. In the case of an all-solid-state battery, the separator 130 may include, for example, a solid electrolyte layer or the like.

Electrolyte

The electrolyte may form an ion conduction path. The liquid electrolyte includes, for example, a lithium salt and a solvent. The lithium-salt may include, for example, LiPF₆. Solvents may include, for example, ethylene carbonate (EC), dimethyl carbonate (DMC), ethyl methyl carbonate (EMC), and the like. The solid-state electrolyte may include, for example, a sulfide (such as Li₃PS₄).

Preparation of Samples

A positive electrode active material according to No. 1 to 14 was produced as follows (see Tables 1 below). Hereinafter, for example, the “positive electrode active material related to No. 1” or the like may be abbreviated as “No. 1”.

No. 1

LNO powder (LiNi_{0.5}Co_{0.2}Mn_{0.3}O₂) was prepared by the co-precipitation method. LNO powder remained un-crushed and was used as a positive electrode active material.

No. 2 to 4

LNO powder of No. 1 was crushed by a dry jet mill in an air atmosphere. The air pressure of the dry jet mill was 0.6 MPa. After crushing, LNO powder was classified by an air flow type classifier in an air atmosphere. Coarse powder and fine powder were cut by classification. As described above, the positive electrode active material was produced.

No. 5

LNO powder (LiNi_{0.6}Co_{0.2}Mn_{0.2}O₂) was prepared by the co-precipitation method. The positive electrode active material was produced by subjecting LNO powder to a crushing treatment and a classifying treatment.

No. 6

LNO powder (LiNi_{0.8}Co_{0.1}Mn_{0.1}O₂) was prepared by the co-precipitation method. The positive electrode active material was produced by subjecting LNO powder to a crushing treatment and a classifying treatment.

No. 7

LNO powder (LiNi_{0.5}Co_{0.2}Mn_{0.3}O₂) was prepared by the co-precipitation method. LNO powder contained porous grains. LNO powder remained un-crushed and was used as a positive electrode active material.

No. 8 to 11

A positive electrode active material was produced by subjecting LNO powder of No. 1 to a crushing treatment and a classification treatment in an inert gas atmosphere (in a nitrogen atmosphere).

No. 12

The positive electrode active material was produced by subjecting LNO powder of No. 5 to a crushing treatment and a classifying treatment.

No. 13

The positive electrode active material was produced by subjecting LNO powder of No. 6 to a crushing treatment and a classifying treatment.

No. 14

LNO powder of No. 10 (after the crushing treatment and the classification treatment) was washed with water and dried to produce a positive electrode active material.

Evaluation

The particle size distribution and specific surface area of each sample were measured. XAFS measurements were performed on the samples to determine the peak-to-height ratio (R). The results are shown in Tables 1˜4 below. In Tables 1 to 4 below, “Y” in the item of “formula (1)” indicates that the relationship of formula (1) is satisfied. “N” indicates that the relationship of formula (1) is not satisfied. The same applies to the item of “formula (2)”.

Test cells for evaluation were made. The configuration of the test battery was as follows.

Positive Electrode
Positive electrode active material: Sample (No. 1 to 14) obtained above
Conductive material: AB
Binder: PVDF

Negative Electrode
Negative electrode active material: Natural graphite
Binder: CMC, SBR
Separator: Porous sheet (24 μm thick)
Electrolyte: electrolyte [LiPF₆ (1 mol/L), EC+DMC+EMC]

The voltage of the rating cell was adjusted to 3.7V. An AC impedance measurement was performed in a thermostat set at −10° C. The magnitude of the arc appearing in the ColorCole plot gave the charge-transfer-resistance (Rct). Rct in Tables 1 to 4 below are relative values where Rct of No. 1 is “1.00”.

### Results and Discussion

(Table 1)

TABLE 1
Sample list

| | Positive electrode active material | | | | | | | | |
|---|---|---|---|---|---|---|---|---|---|
| | | | | | | | Formula | | |
| | | | | | | | (1) | Formula | Evaluation |
| | | Crushing | BET | D50 | XAFS | | 0.1 ≤ | (2) | Rct |
| No. | LNO composition | atmosphere | [m²/g] | [μm] | R | dR² | dR² ≤ 0.4 | d ≤ 2.7 | [—] |
| 1 | LiNi_{0.5}Co_{0.2}Mn_{0.3}O₂ | Uncrushed | 0.3 | 7.0 | 0.30 | 0.64 | N | N | 1.00 |
| 2 | LiNi_{0.5}Co_{0.2}Mn_{0.3}O₂ | Air | 1.3 | 2.7 | 0.45 | 0.55 | N | Y | 0.93 |
| 3 | LiNi_{0.5}Co_{0.2}Mn_{0.3}O₂ | Air | 1.7 | 1.5 | 0.53 | 0.42 | N | Y | 0.98 |
| 4 | LiNi_{0.5}Co_{0.2}Mn_{0.3}O₂ | Air | 2.1 | 1.2 | 0.63 | 0.47 | N | Y | 1.12 |
| 5 | LiNi_{0.6}Co_{0.2}Mn_{0.2}O₂ | Air | 0.4 | 1.4 | 0.73 | 0.75 | N | Y | 1.45 |
| 6 | LiNi_{0.8}Co_{0.1}Mn_{0.1}O₂ | Air | 0.3 | 1.7 | 0.71 | 0.85 | N | Y | 1.5 |
| 7 | LiNi_{0.5}Co_{0.2}Mn_{0.3}O₂ | Uncrushed | 2.1 | 5.3 | 0.40 | 0.85 | N | N | 0.92 |
| 8 | LiNi_{0.5}Co_{0.2}Mn_{0.3}O₂ | Inert gas | 1.2 | 2.7 | 0.32 | 0.27 | Y | Y | 0.90 |
| 9 | LiNi_{0.5}Co_{0.2}Mn_{0.3}O₂ | Inert gas | 1.7 | 1.5 | 0.33 | 0.16 | Y | Y | 0.88 |
| 10 | LiNi_{0.5}Co_{0.2}Mn_{0.3}O₂ | Inert gas | 2.1 | 1.2 | 0.38 | 0.17 | Y | Y | 0.85 |
| 11 | LiNi_{0.5}Co_{0.2}Mn_{0.3}O₂ | Inert gas | 2.5 | 1.0 | 0.45 | 0.20 | Y | Y | 0.91 |
| 12 | LiNi_{0.6}Co_{0.2}Mn_{0.2}O₂ | Inert gas | 1.7 | 1.4 | 0.45 | 0.28 | Y | Y | 0.92 |
| 13 | LiNi_{0.8}Co_{0.1}Mn_{0.1}O₂ | Inert gas | 1.4 | 1.6 | 0.49 | 0.38 | Y | Y | 0.94 |
| 14 | LiNi_{0.5}Co_{0.2}Mn_{0.3}O₂ | Inert gas | 2.1 | 1.2 | 0.21 | 0.05 | N | Y | 1.20 |

Note:
No. 7 is a powder containing porous particles (secondary particles).
No. 14 is washed with water after the crushing treatment and the classification treatment in an inert gas atmosphere.

Note:
No. 7 is a powder containing porous particles (secondary particles).
No. 14 is washed with water after the crushing treatment and the classification treatment in an inert gas atmosphere.

TABLE 2
Tables 2 dR² value

| | Positive electrode active material | | | | | | | | |
|---|---|---|---|---|---|---|---|---|---|
| | | | | | | | Formula | | |
| | | | | | | | (1) | Formula | Evaluation |
| | | Crushing | BET | D50 | XAFS | | 0.1 ≤ | (2) | Rct |
| No. | LNO composition | atmosphere | [m²/g] | [μm] | R | dR² | dR² ≤ 0.4 | d ≤ 2.7 | [—] |
| 1 | LiNi_{0.5}Co_{0.2}Mn_{0.3}O₂ | Uncrushed | 0.3 | 7.0 | 0.30 | 0.64 | N | N | 1.00 |
| 2 | LiNi_{0.5}Co_{0.2}Mn_{0.3}O₂ | Air | 1.3 | 2.7 | 0.45 | 0.55 | N | Y | 0.93 |
| 3 | LiNi_{0.5}Co_{0.2}Mn_{0.3}O₂ | Air | 1.7 | 1.5 | 0.53 | 0.42 | N | Y | 0.98 |
| 4 | LiNi_{0.5}Co_{0.2}Mn_{0.3}O₂ | Air | 2.1 | 1.2 | 0.63 | 0.47 | N | Y | 1.12 |
| 8 | LiNi_{0.5}Co_{0.2}Mn_{0.3}O₂ | Inert gas | 1.2 | 2.7 | 0.32 | 0.27 | Y | Y | 0.90 |
| 9 | LiNi_{0.5}Co_{0.2}Mn_{0.3}O₂ | Inert gas | 1.7 | 1.5 | 0.33 | 0.16 | Y | Y | 0.88 |
| 10 | LiNi_{0.5}Co_{0.2}Mn_{0.3}O₂ | Inert gas | 2.1 | 1.2 | 0.38 | 0.17 | Y | Y | 0.85 |
| 11 | LiNi_{0.5}Co_{0.2}Mn_{0.3}O₂ | Inert gas | 2.5 | 1.0 | 0.45 | 0.20 | Y | Y | 0.91 |
| 14 | LiNi_{0.5}Co_{0.2}Mn_{0.3}O₂ | Inert gas | 2.1 | 1.2 | 0.21 | 0.05 | N | Y | 1.20 |

Note:
No. 14 is washed with water after the crushing treatment and the classification treatment in an inert gas atmosphere.

Note:
No. 14 is washed with water after the crushing treatment and the classification treatment in an inert gas atmosphere.

In the above Table 2, when the relationships of the above formulas (1) and (2) are satisfied, the resistance tends to be reduced.

No. 2 to 4 tend to be highly resistive. In No. 2 to 4, the crushing treatment is performed in an air atmosphere. dR² is considered to be greater than 0.4 because of the large generation of resistive components.

No. 9 to 11 tends to be relatively less resistive than No. 2 to 4. In No. 9 to 11, a crushing treatment is performed in an inert gas atmosphere. By suppressing the generation of resistive components, it is considered that dR² is within 0.4 or less.

No. 14 is highly resistive. In No. 14, after the crushing treatment in an inert gas atmosphere, a water washing treatment is performed. It is considered that dR² is less than due to the reduction of the resistive components by the water washing treatment. However, it is considered that the resistance is increased by deactivation of a part of the reaction surface by the water washing treatment.

TABLE 3
3 Ni ratio

| | Positive electrode active material | | | | | | | | |
|---|---|---|---|---|---|---|---|---|---|
| | | | | | | | Formula | | |
| | | | | | | | (1) | Formula | Evaluation |
| | | Crushing | BET | D50 | XAFS | | 0.1 ≤ | (2) | Rct |
| No. | LNO composition | atmosphere | [m²/g] | [μm] | R | dR² | dR² ≤ 0.4 | d ≤ 2.7 | [—] |
| 3 | LiNi_{0.5}Co_{0.2}Mn_{0.3}O₂ | Air | 1.7 | 1.5 | 0.53 | 0.42 | N | Y | 0.98 |
| 5 | LiNi_{0.6}Co_{0.2}Mn_{0.2}O₂ | Air | 0.4 | 1.4 | 0.73 | 0.75 | N | Y | 1.45 |
| 6 | LiNi_{0.8}Co_{0.1}Mn_{0.1}O₂ | Air | 0.3 | 1.7 | 0.71 | 0.85 | N | Y | 1.5 |
| 9 | LiNi_{0.5}Co_{0.2}Mn_{0.3}O₂ | Inert gas | 1.7 | 1.5 | 0.33 | 0.16 | Y | Y | 0.88 |
| 12 | LiNi_{0.6}Co_{0.2}Mn_{0.2}O₂ | Inert gas | 1.7 | 1.4 | 0.45 | 0.28 | Y | Y | 0.92 |
| 13 | LiNi_{0.8}Co_{0.1}Mn_{0.1}O₂ | Inert gas | 1.4 | 1.6 | 0.49 | 0.38 | Y | Y | 0.94 |

In the above-described Tables 3, when Ni ratio of LNO is 0.5 or more, it does not depend on Ni ratio.

TABLE 4
Tabular 4 BET

| | Positive electrode active material | | | | | | | | |
|---|---|---|---|---|---|---|---|---|---|
| | | | | | | | Formula | | |
| | | | | | | | (1) | Formula | Evaluation |
| | | Crushing | BET | D50 | XAFS | | 0.1 ≤ | (2) | Rct |
| No. | LNO composition | atmosphere | [m²/g] | [μm] | R | dR² | dR² ≤ 0.4 | d ≤ 2.7 | [—] |
| 7 | LiNi_{0.5}Co_{0.2}Mn_{0.3}O₂ | Uncrushed | 2.1 | 5.3 | 0.40 | 0.85 | N | N | 0.92 |
| 10 | LiNi_{0.5}Co_{0.2}Mn_{0.3}O₂ | Inert gas | 2.1 | 1.2 | 0.38 | 0.17 | Y | Y | 0.85 |

Note:
No. 7 is a powder containing porous particles (two-dimensional particles).

Note:
No. 7 is a powder containing porous particles (secondary particles).

In No. 7 of the above-described Tables 4, the reacted area is increased by making the secondary particles porous instead of crushing the secondary particles. No. 7 has a relatively large D50 while having a specific surface area comparable to that of No. 10 (crushed powder). However, No. 7 is more resistive than No. 10. Since the inner surface of the porous particle is not exposed to the outside, it is considered that it is difficult to function as an effective reaction surface. dR² of No. 7 exceeds 0.4.

What is claimed is:

1. A positive electrode active material comprising lithium nickel composite oxide powder, wherein:
relationships of the following formula (1) and the following formula (2) are satisfied:
0.1≤d×R×R≤0.4 (1),
and d≤2.7 (2); and
in the above formula (1) and the above formula (2),
d has a unit of μm, and represents D50 of the lithium nickel composite oxide powder,
R is a dimensionless quantity, and represents a ratio of a height of a second peak with respect to a height of a first peak in an absorption spectrum of oxygen by X-ray absorption fine structure spectroscopy,
the first peak has a peak top within 529 eV to 530 eV, and
the second peak has a peak top within 533 eV to 534 eV.

2. The positive electrode active material according to claim 1, wherein a relationship of the following formula (3) is further satisfied:
0.32≤R≤0.49 (3).

3. The positive electrode active material according to claim 1, wherein a ratio of an amount of substance of Ni with respect to a total amount of substance of atoms other than Li and oxygen in the lithium nickel composite oxide powder is 0.5 or more.

4. The positive electrode active material according to claim 3, wherein:
the lithium nickel composite oxide powder has a composition represented by the following formula (4):
Li₍₁₊ₓ₎Ni_{y}Co_{z}Mn_{(1-y-z)}MaO_{(2-b)}C_{b} (4); and
in the formula (4),
x, y, z, a, and b satisfy relationships of 0≤x≤0.7, 0.5≤y≤0.8, 0.1≤z≤0.2, 0≤a≤0.1, and 0≤b≤0.5, respectively,
M is at least one selected from the group consisting of Zr, Mo, W, Mg, Ca, Na, Fe, Cr, Zn, Si, Sn, Al, and Ag, and
C is at least one selected from the group consisting of F, Cl, and Br.

5. A positive electrode comprising the positive electrode active material according to claim 1.

6. A lithium ion battery comprising the positive electrode according to claim 5.

7. A method for producing a positive electrode active material, the method comprising:
(a) preparing lithium nickel composite oxide powder; and
(b) producing the positive electrode active material by crushing the lithium nickel composite oxide powder in an inert gas atmosphere.
